(19) United States
(12) Patent Application Publication
(10) Pub. No.: US 2022/0264987 A1
(43) Pub. Date: Aug. 25, 2022

(54) HUMAN WEAR MOUNTABLE ELECTRONIC SYSTEM FOR NEAR PROXIMITY MONITORING

(71) Applicant: Alexey Kudymov, Three Bridges, NJ (US)

(72) Inventors: Ilya Kudymov, Ringoes, NJ (US); Alexey Kudymov, Three Bridges, NJ (US)

(73) Assignee: Waddle Electronics LLC, Ringoes, NJ (US)

(21) Appl. No.: 17/180,772

(22) Filed: Feb. 20, 2021

(51) Int. Cl. A43B 3/00; G01S 1/00

(52) U.S. Cl. CPC A43B 3/0021; G01S 1/00; G09B 21/006

(57) ABSTRACT

The present invention introduces an alarm circuit that detects potentially dangerous objects in the proximity during human activities, such as walking or running. The circuit is designed mostly to prevent stumbling for the people with temporary or permanent visual impairment conditions but can be used to prevent physical accidents under other circumstances as well. The circuit of the present invention can be permanently or temporarily mounted on human shoes, clothes, or other wearing means, including body parts. The placement of the circuit of the present invention includes but is not limited to the previously mentioned ones.

### BACKGROUND OF THE INVENTION

The present invention relates to the human interacting electronic systems, and in particular, to the assisting and alarm systems. In more detail, the invention presents an assistive personal proximity monitoring system that can alarm the user regarding the objects appearing nearby, from a distance of approximately an inch to a distance of approximately three feet or similar.

There are a number of human conditions and/or activities that do not allow for a visual monitoring or recognition of the objects in the nearby proximity, such as in a touch distance. For example, people who are visually impaired cannot efficiently monitor the immediate surrounding as they walk. Currently, such people have to use special mechanical tools (such as a “white cane”) or the help of other people or specially trained animals.

Another example of human conditions that would benefit from an assistive personal proximity monitoring system of the present invention are the night or dark environment walkers and workers, as well as people that are using dark helmets/eye protective equipment, like welders.

Yet another example of the human activity that would benefit from an assistive personal proximity monitoring system of the present invention is bulk items moving activity, including but not limited to, for example, stairs climbing or busy environment, for example at a construction site. People moving bulk items often cannot see what is on the ground ahead their step because their vision is blocked by the item(s) they are moving.

The above examples are intended to illustrate the present invention but in no way to limit its scope. There are many other possible applications of the assistive personal proximity monitoring system of the present invention that can be foreseen or might be discovered in the future.

### SUMMARY OF THE INVENTION

An electronic system of the present invention comprises one or more proximity sensors, and a human interacting interface. The system further comprises the energy storage means that can be either replaceable battery, or rechargeable battery, or the like. The system may further optionally comprise a logic circuit that receives the signal from the proximity sensor, generates the input for the human interacting interface and optionally controls the power supply. The system may further optionally comprise a wireless communicating subsystem, such as but not limited to a Bluetooth communicating unit that provides the proximity sensors signal or logic circuit output exchange to the human interacting interface.

The electronic system of the present invention can be integrated with the shoes or clothes. In another embodiment of the invention, it can be mountable and removable on top of a shoe or cloth.

The electronic system of the present invention is designed to generate and deliver the alarm signal to the user in case the proximity sensor detects objects within its sensitivity window. The aforementioned alarm signal can be an audible signal, or mechanical vibration, or any other type of signal that is easy for a human to detect and identify.

### BRIEF DESCRIPTION OF THE DRAWINGS

FIG. 1 represents the set of components comprising one of the embodiments of the electronic system of the present invention.

FIG. 2.a illustrates one of the arrangements of the components of the electronic system of the present invention mountable on the front side of a shoe.

FIG. 2.b illustrates another arrangement of the components of the electronic system of the present invention mountable on the front side of a shoe.

FIG. 3.a illustrates one of the arrangements of the components of the electronic system of the present invention hard mounted to the front side of a shoe.

FIG. 3.b illustrates another arrangement of the components of the electronic system of the present invention hard mounted to the front side of a shoe.

FIG. 4.a illustrates yet another arrangement of the components of the electronic system of the present invention mountable on the front side of a shoe.

FIG. 4.b illustrates yet another arrangement of the components of the electronic system of the present invention hard mounted to the front side of a shoe.

FIG. 5 illustrates the proximity sensor comprised by the electronic system of the present invention mounted on top of the contractor's hard hat.

FIG. 6 represents two possible sensitivity diagrams of the proximity sensor comprised by the electronic system of the present invention mounted on the front side of a shoe.

### DETAILED DESCRIPTION OF THE DRAWINGS

Several embodiments of the present invention as described below, in conjunction with the Figures provided, are not intended to limit the scope of the invention but to illustrate the structure and components of the electronic system therein and its applications.

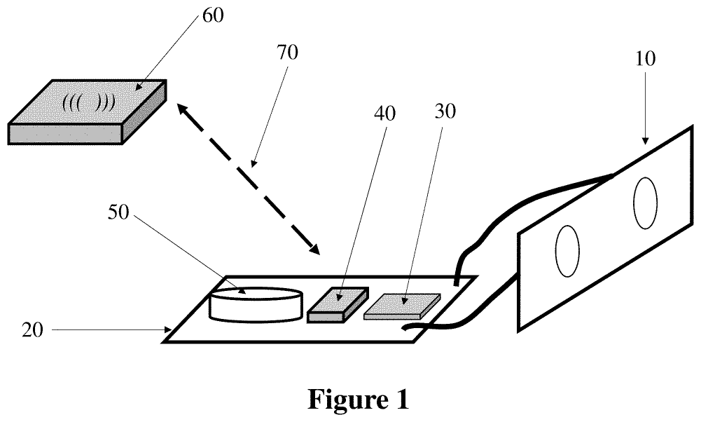

FIG. 1 provides a schematic set of the components comprised by the electronic circuit of the present invention. The proximity sensor 10 is connected to the circuit board 20 that carries an optional logic circuit 30, an optional wireless communication unit 40, and a power supply 50. The optional wireless communication unit 40 is used to exchange wirelessly the control signals with a human interacting interface 60.

It can be easily discovered by a skilled artisan that some of the optional components of the electrical system of FIG. 1 can be omitted in order to make the said system cheaper and simpler. Depending on the choice and design of a particular proximity sensor 10, the logic circuit 30 may not be needed. In some of the embodiments illustrated by other Figures, the human interacting interface 60 can be wired to the circuit board 20 or directly to the proximity sensor 10; in this case, the system may not need the optional wireless communication unit 40.

The power supply 50 can be either replaceable or rechargeable. In one of the embodiments, the replaceable power supply can be a compact “tablet” battery. In another embodiment, it can be a rechargeable battery with a connector to an external power supply, to recharge it overnight or when not in use. In yet another embodiment, the rechargeable element 50 can get charged from the energy of a human motion, for example from the energy developed by a piezo element that is getting mechanically stressed by the details of the shoes or clothes while the user walks.

A human interacting interface can be a small speaker or a vibrating unit. As an alternative, the electrical system of a present invention can connect to commercial human interface devices, such as smartphones, smart watches, electronic trackers etc. It can also communicate directly to wireless or wired headphones. The Figures described below represent but not limit various embodiment regarding the location and connection of the proximity sensor and human interacting interface.

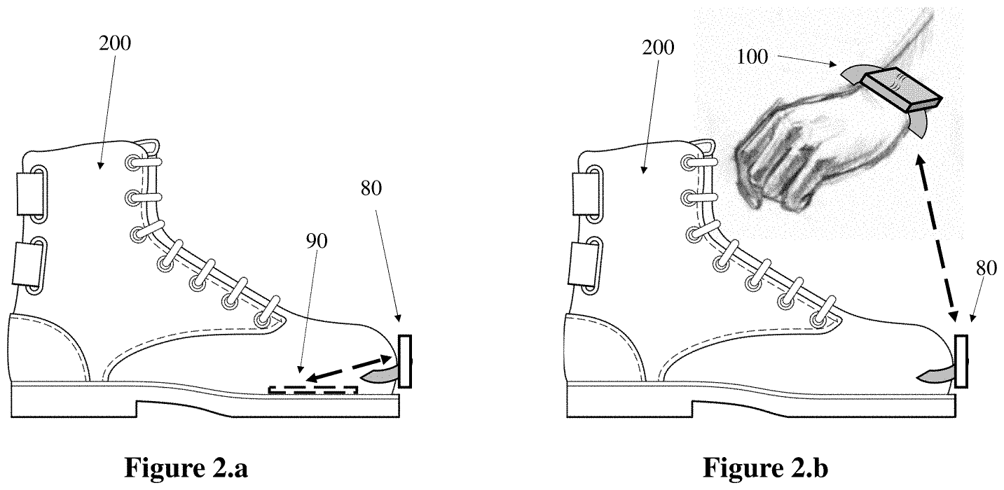

In FIG. 2.a, a part of an electronic system of the present invention 80 comprising a proximity sensor is temporarily mountable on the outer front surface of a human shoe 200 using mechanical temporary mount means. Examples of such means, without limiting the invention scope, are Velcro or plastic pressure arc (similar to a headband). The human interacting interface 90 is placed inside the shoe (and shown by a dashed line). It can be, for example, mounted under the insole and produce a vibration at an event the proximity sensor of the electrical system of the present invention detects an object in the proximity. The optional elements of the system, such as logic circuit and wireless communication unit, can be combined together with a part 80 comprising a proximity sensor, or with a human communicating interface 90. The last is less preferable since it may disturb the quality of walking. The power supply can be attached to either system parts 80, 90, or both.

In FIG. 2.b, the part of an electronic system 80 is temporarily mounted on the outer front surface of a human shoe 200, while the human interacting interface 100 is attached to a human wrist in a form of a bracelet, smart watch or an activity tracking device. An engineer skilled in the art will acknowledge that the location of the human interacting device may not be limited to a wrist, and can appear on a human arm, shoulder, or any other part of a body.

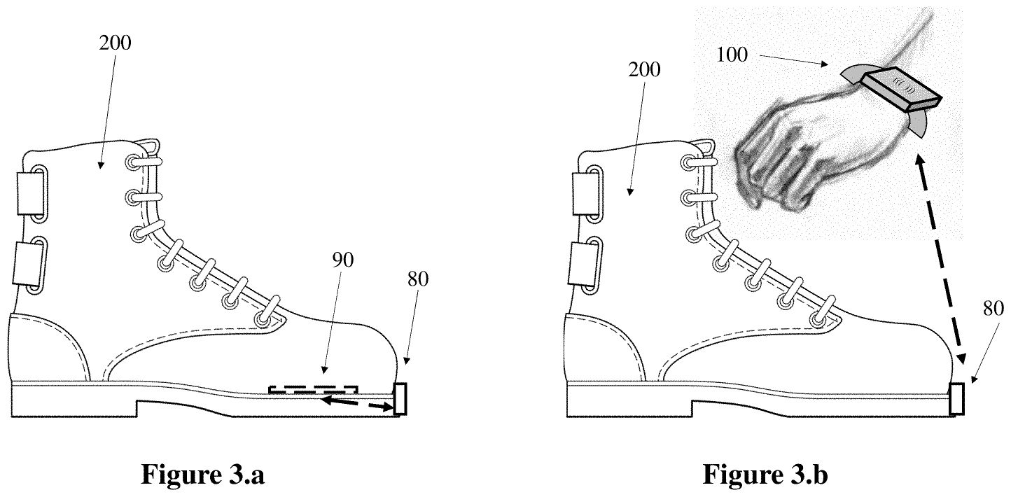

In FIG. 3.a, a part of an electronic system of the present invention 80 comprising a proximity sensor is permanently mounted to the outer front surface of a human shoe 200, while the human interacting interface 90 is placed inside the shoe, similar to FIG. 2.a.

In FIG. 3.b, a part of an electronic system of the present invention 80 comprising a proximity sensor is also permanently mounted to the outer front surface of a human shoe 200, while the human interacting interface 100 is attached to a human wrist in a form of a bracelet, smart watch or an activity tracking device, similar to FIG. 2.b.

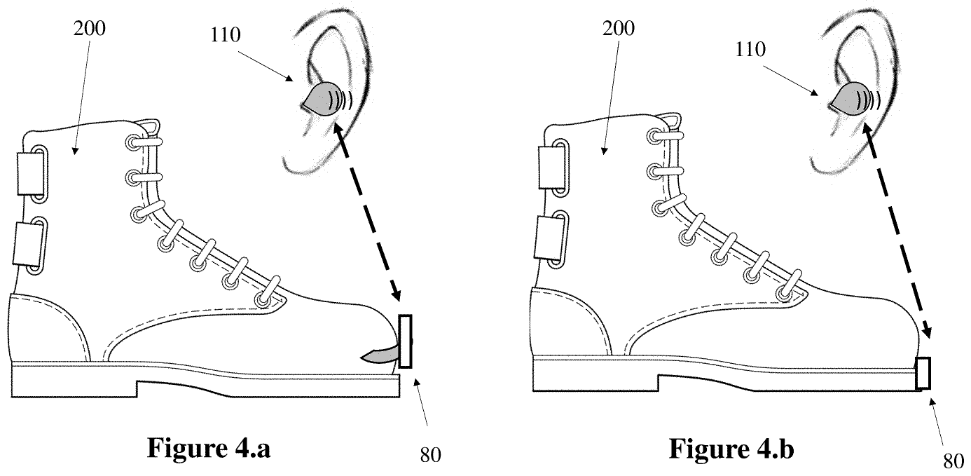

In FIG. 4.a, a part of an electronic system of the present invention 80 comprising a proximity sensor is temporarily mounted on the outer front surface of a human shoe 200, while the human interacting interface 110 is placed in or next to a human ear, in a form of a headphone, hearing aid, or the like.

In FIG. 4.b, a part of an electronic system of the present invention 80 comprising a proximity sensor is permanently mounted to the outer front surface of a human shoe 200, while the human interacting interface 110 is placed in or next to a human ear, in a form of a headphone, hearing aid, or the like, similar to FIG. 4.a.

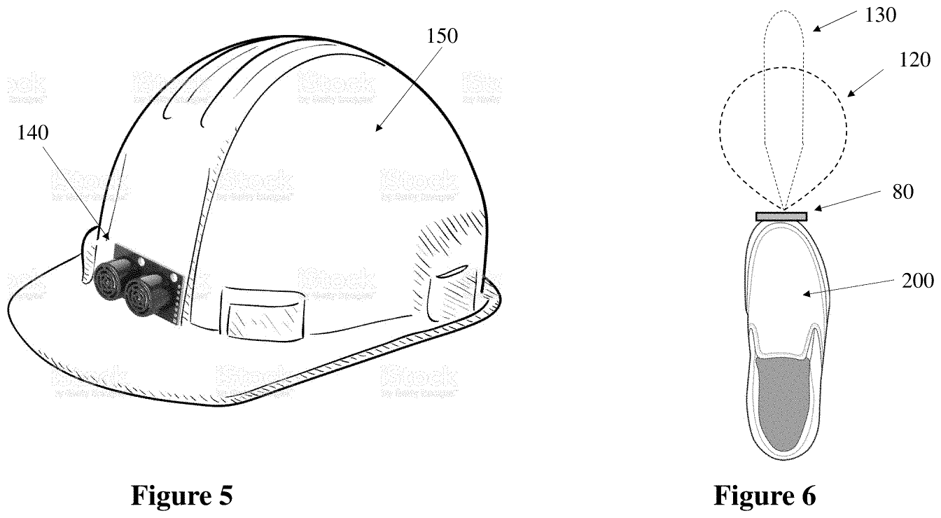

In FIG. 5, a part of an electronic system of the present invention comprising a proximity sensor 140 is mounted on the front outer surface of a contractor hard hat 150. The location and way of mounting of other parts of the electronic system is not specified in order to avoid limiting the scope of the present invention; a skilled artisan will discover many options for the placement of these.

There exist several technologies producing the proximity sensors. The most widely represented are capacitive, inductive, infrared, and ultrasound. The choice of the proximity sensor technology dictates what type of objects, at what distance and at which angle the sensor will detect. Since for the purpose of the present invention, the detection distance and angle are the most important characteristics, the proximity sensor must be chosen to match the following requirements.

Since the main intention of the electronic system in the present invention is to alert the user about potentially dangerous objects during walking, to prevent stumbling, an optimal detection distance must be within 1-2 steps, or 2-3 feet. At the same time, the objects that are not in the direction of walking do not represent the danger to a walker, so it is preferred to use the proximity sensors with narrow sensitivity window (angle). In addition, the proximity sensor of the choice must be solar blind, or must not be saturated, inactivated or in any other sense altered by the sunlight. It is also preferred that the sensor is not sensitive to the presence of dust, dirt, or sleet.

In FIG. 6, the top view of a shoe 200 with attached proximity sensor 80 is provided schematically, demonstrating two possible sensitivity diagrams of the said sensor 80. The sensor having a sensitivity diagram similar to a diagram 120 (wide angle) will produce a lot of false signals from the objects that are not in a direct walking path. If possible, a sensitivity diagram 130 is preferred for the scope of the present invention.

The preferred requirements for the proximity sensor provided above can be satisfied, for example, by the ultrasound proximity sensors. As an example of a suitable ultrasound proximity sensor, part number MB1604-000 produced by MaxBotix Inc. can be adopted. This part is commercially available and is cost effective, compared to other types of proximity sensors. The part also produces the electric signal that allows to determine the actual distance to the selected object, which may be helpful for the optional logic circuit to generate accurate and informative alarm signals.

In order to illustrate the preferred embodiment for the proximity sensor selection for the present invention implementation, the proximity sensor 140 in FIG. 5 is a datasheet image or a part number MB1604-000 produced by MaxBotix Inc. The use of the stock/datasheet picture is, however, not intended to limit the scope of the present invention, since different suitable proximity sensors may be available to the skilled artisan nowadays or in the future.

1. An electronic system comprising:
a. A proximity sensor;
b. A logic circuitry;
c. A wireless transmitter;
d. A human communicating means;
e. A power source.

2. The electronic system of claim 1 where the proximity sensor is targeting the distance range from approximately 2 centimeters to approximately 1 meter.

3. The electronic system of claim 1 where the logic circuitry is designed in part to receive the signal from the said proximity sensor and generate the input signal to the said wireless transmitter.

4. The electronic system of claim 1 where the human communicating means are used to generate a signal recognizable by a human user.

5. The electronic system of claim 1 that is portable and can be mounted in part on a human body.

6. The electronic system of claim 1 that is portable and can be mounted in part on a human clothing.

7. The electronic system of claim 1 that is portable and can be mounted in part on human shoes.

8. The electronic system of claim 1 where the human communicating means is providing a mechanical vibration detectable by a human user in response to a signal generated by a wireless transmitter.

9. The electronic system of claim 1 where the power source is a replaceable tablet battery.

10. The electronic system of claim 1 where the power source is a rechargeable battery.

11. The electronic system of claim 10 where the said battery is rechargeable through a standard USB interface.

12. The electronic system of claim 10 where the said battery is rechargeable through a wireless transmitter (charging pad).

13. The electronic system of claim 10 where the said battery is rechargeable from the energy of a human motion.
